(19) United States
(12) Patent Application Publication
(10) Pub. No.: US 2015/0036757 A1
(43) Pub. Date: Feb. 5, 2015

(54) SYSTEMS AND METHODS FOR ADAPTIVELY APPLYING A DEBLOCKING FILTER

(71) Applicant: DIVX, LLC, Santa Clara, CA (US)

(72) Inventors: Martin Schink, Aachen (DE); Thomas Kramer, Pulheim (DE)

(73) Assignee: DIVX, LLC, Santa Clara, CA (US)

(21) Appl. No.: 13/955,888

(22) Filed: Jul. 31, 2013

(51) Int. Cl. H04N 19/117; H04N 19/86; H04N 19/176; H04N 19/146

(52) U.S. Cl. CPC H04N 19/00066; H04N 19/00169; H04N 19/00909; H04N 19/00278
USPC 375/240.29

(57) ABSTRACT

Systems and methods for adaptively applying a deblocking filter using a maximum bitrate and/or resolution thresholds are disclosed. In one embodiment, post-processing encoded video data utilizing an adaptive deblocking filter include determining threshold values for maximum bitrate and resolution of encoded video based upon a minimum acceptable video quality for a playback device, selecting a video stream comprising encoded video data with an associated maximum bitrate and resolution, where the video stream is selected based upon an available bandwidth between the playback device and a content distribution server, obtaining encoded video data for a portion of the video stream, decoding the video data for the portion of the video stream, adaptively applying the deblocking filter to the decoded video data for the portion of the video stream, where the deblocking filter is applied utilizing at least one of the determined maximum bitrate and resolution thresholds.

### FIELD OF THE INVENTION

The present invention generally relates to post-processing of video content and more specifically to systems and methods for adaptively applying a deblocking filter to decoded video content utilizing bitrate and/or resolution thresholds.

### BACKGROUND

Video codecs can enable the compression and/or decompression of digital video for sharing of video files (which can include video and audio data). In developing video codecs, factors such as preserving video quality at playback, data quantity required to encode the video, complexity of the encoding and decoding algorithms, and robustness to data losses and errors are typically considered. Many codecs encode using lossy techniques where the video file is compressed by discarding select portions of the original data. When a lossy technique is used, the original video cannot be reconstructed. However, the information that is lost is chosen so as to minimize the impact on the decoded video quality.

Although there are many video codecs available, a number of standards have been developed and implemented by industry. H. 264 is a widely used standard developed by the Telecommunication Standardization Sector's Video Coding Experts Group together with the International Organization for Standardization (ISO), International Electro technical Commission (IEC) and Moving Picture Experts Group (MPEG). H.264 utilizes a lossy block-oriented motion-compensation based codec.

A block-oriented motion-compensation technique divides a frame into so called macroblocks for processing. The technique leverages redundancy in pixel values both within an individual frame and between successive frames to reduce the amount of data used to represent the video content. Using a reference macroblock, the encoder forms a prediction of the macroblock based on previously coded data either from the current frame (intra prediction) or from previous frames (inter prediction). The encoder typically subtracts the prediction from the current macroblock to form a so called residual macroblock.

In many such standards, each residual macroblock is transformed using a block transform (such as discrete cosine transform) and the resulting transform coefficients are quantized to give a set of quantized transform coefficients. Quantization typically involves dividing each transform coefficient by an integer value using a quantization matrix or quantization parameter. Setting high integer values results in more coefficients being rounded to zero resulting in higher compression. However, high quantization also leads to increased information loss and particularly the loss of information where variations between macroblocks are greater (e.g. areas of observed motion and color changes). When higher compression levels are utilized and loss of information is greater, distortions such as blocking artifacts between macroblocks become more noticeable during playback.

### SUMMARY OF THE INVENTION

Systems and methods for adaptively applying a deblocking filter using a maximum bitrate and/or resolution thresholds are disclosed. In one embodiment, post-processing encoded video data utilizing an adaptive deblocking filter include determining threshold values for maximum bitrate and resolution of encoded video based upon a minimum acceptable video quality for a playback device, selecting a video stream comprising encoded video data with an associated maximum bitrate and resolution, where the video stream is selected based upon an available bandwidth between the playback device and a content distribution server, obtaining encoded video data for a portion of the video stream with the associated maximum bitrate and resolution from the content distribution server, decoding the video data for the portion of the video stream, adaptively applying the deblocking filter to the decoded video data for the portion of the video stream, where the deblocking filter is applied utilizing at least one of the determined maximum bitrate and resolution thresholds.

In a further embodiment, determining threshold values for maximum bitrate and resolution parameters of encoded video also includes loading the maximum bitrate and resolution thresholds from a non-volatile memory.

In another embodiment, the minimum acceptable video quality for a playback device also includes determining an acceptable combination of bitrate and resolution for the playback device.

In a still further embodiment, the acceptable combination of bitrate and resolution for the playback device is based upon a native resolution of the playback device.

In still another embodiment, the acceptable combination of bitrate and resolution for the playback device is based upon an amount of motion in the video content.

In a yet further embodiment, the acceptable combination of bitrate and resolution for the playback device is based upon processing capacities of the playback device.

In yet another embodiment, the deblocking filter is a video filter that can be applied to decoded compressed video data to improve visual quality by smoothing edges between macroblocks.

In a further embodiment again, the deblocking filter is a video filter that can be applied to decoded compressed video data to improve prediction performance by smoothing edges between macroblocks.

In another embodiment again, adaptively applying the deblocking filter also includes applying the deblocking filter to the decoded video data from the portion of the video stream when the associated maximum bitrate and resolution of the obtained encoded video data is below the maximum bitrate and resolution thresholds.

In a further additional embodiment, adaptively applying the deblocking filter also includes not applying the deblocking filter to the decoded video data from the portion of the video stream when the associated maximum bitrate and resolution of the obtained encoded video data is above the maximum bitrate and resolution thresholds.

In another additional embodiment, the deblocking filter is applied based upon a comparison between the associated maximum bitrate of the obtained encoded video data and the maximum bitrate threshold.

In a still yet further embodiment, the deblocking filter is applied based upon a comparison between the associated resolution of the obtained encoded video data and the resolution threshold.

In still yet another embodiment, a playback device for providing playback by post-processing encoded video data utilizing an adaptive deblocking filter includes: memory, and a processor configured via an application stored in the memory to: determine threshold values for maximum bitrate and resolution of encoded video based upon a minimum acceptable video quality for the playback device, select a video stream comprising encoded video data with an associated maximum bitrate and resolution, where the video stream is selected based upon an available bandwidth between the playback device and a content distribution server, obtain encoded video data for a portion of the video stream with the associated maximum bitrate and resolution from the content distribution server, decode the video data for the portion of the video stream, and adaptively apply the deblocking filter to the decoded video data for the portion of the video stream, where the deblocking filter is applied utilizing at least one of the determined maximum bitrate and resolution thresholds.

In a still further embodiment again, the processor configured via an application stored in the memory to determine threshold values for maximum bitrate and resolution parameters of encoded video also includes loading the maximum bitrate and resolution thresholds from the memory.

In still another embodiment again, the minimum acceptable video quality for a playback device also includes determining an acceptable combination of bitrate and resolution for the playback device.

In a still further additional embodiment, the acceptable combination of bitrate and resolution for the playback device is based upon a native resolution of the playback device.

In still another additional embodiment, the acceptable combination of bitrate and resolution for the playback device is based upon an amount of motion in the video content.

In a yet further embodiment again, the acceptable combination of bitrate and resolution for the playback device is based upon processing capacities of the playback device.

In yet another embodiment again, the deblocking filter is a video filter that can be applied to decoded compressed video data to improve visual quality by smoothing edges between macroblocks.

In a yet further additional embodiment, the deblocking filter is a video filter that can be applied to decoded compressed video data to improve prediction performance by smoothing edges between macroblocks.

In yet another additional embodiment, the processor configured via an application stored in the memory to adaptively apply the deblocking filter also includes applying the deblocking filter to the decoded video data from the portion of the video stream when the associated maximum bitrate and resolution of the obtained encoded video data is below the maximum bitrate and resolution thresholds.

In a further additional embodiment again, the processor configured via an application stored in the memory to adaptively apply the deblocking filter also includes not applying the deblocking filter to the decoded video data from the portion of the video stream when the associated maximum bitrate and resolution of the obtained encoded video data is above the maximum bitrate and resolution thresholds.

In another additional embodiment again, the deblocking filter is applied based upon a comparison between the associated maximum bitrate of the obtained encoded video data and the maximum bitrate threshold.

In a still yet further embodiment again, the deblocking filter is applied based upon a comparison between the associated resolution of the obtained encoded video data and the resolution threshold.

In still yet another embodiment again, a plurality of applications are stored in the memory, wherein one application from the plurality of applications configures the processor to obtain encoded video data for a portion of the video stream and another application from the plurality of applications configures the processor to decode the video data.

In a still yet further additional embodiment, the application that configures the processor to obtain encoded video data from a portion of the video stream also configures the processor to measure the bitrate of the obtained video data and instructs the application that configures the processor to decode the video data to adaptively apply the deblocking filter to the decoded video data for the portion of the video stream based on the measured bitrate.

In still yet another additional embodiment, a machine readable medium containing processor instructions, where execution of the instructions by a processor causes the processor to perform a process for adaptively applying a deblocking filter to decoded video data, the process includes determining threshold values for maximum bitrate and resolution of encoded video based upon a minimum acceptable video quality for a playback device, selecting a video stream comprising encoded video data with an associated maximum bitrate and resolution, where the video stream is selected based upon an available bandwidth between the playback device and a content distribution server, obtaining encoded video data for a portion of the video stream with the associated maximum bitrate and resolution from the content distribution server, decoding the video data for the portion of the video stream; and adaptively applying the deblocking filter to the decoded video data for the portion of the video stream, where the deblocking filter is applied utilizing at least one of the determined maximum bitrate and resolution thresholds.

In a yet further additional embodiment again, the machine readable medium containing processor instructions, where adaptively applying the deblocking filter also includes applying the deblocking filter to the decoded video data from the portion of the video stream when the associated maximum bitrate and resolution of the obtained encoded video data is below the maximum bitrate and resolution thresholds.

In yet another additional embodiment again, the machine readable medium containing processor instructions, where adaptively applying the deblocking filter also includes not applying the deblocking filter to the decoded video data from the portion of the video stream when the associated maximum bitrate and resolution of the obtained encoded video data is above the maximum bitrate and resolution thresholds.

### BRIEF DESCRIPTION OF THE DRAWINGS

FIG. 1 is a system diagram of a video distribution system in accordance with an embodiment of the invention.

FIG. 2A illustrates a source encoder in accordance with an embodiment of the invention.

FIG. 2B illustrates a playback device in accordance with an embodiment of the invention.

FIG. 2C illustrates a content distribution server in accordance with an embodiment of the invention.

FIG. 3 is a flow chart illustrating a process for post-processing decoded video data by adaptively applying a deblocking filter in accordance with an embodiment of the invention.

FIG. 4 is a flow chart illustrating a process for setting maximum bitrate and resolution thresholds by determining a minimum acceptable combination of bitrate and resolution for a playback device in accordance with an embodiment of the invention.

FIG. 5 is a flow chart illustrating a process for obtaining video data for a portion of a video stream at an appropriate maximum bitrate and resolution in accordance with an embodiment of the invention.

FIG. 6 is a flow chart illustrating a process for adaptively applying a deblocking filter utilizing maximum bitrate and/or resolution thresholds in accordance with an embodiment of the invention.

### DETAILED DESCRIPTION

Turning now to the drawings, systems and methods for adaptively applying a deblocking filter using a maximum bitrate and/or resolution thresholds are illustrated. In many embodiments, threshold values for maximum bitrate and resolution of encoded video are determined based upon a minimum acceptable video quality for a particular playback device. In several embodiments, the system selects a video stream comprising of encoded video data with an associated maximum bitrate and resolution, where the video stream is selected based upon the available bandwidth between the playback device and a content distribution server. In various embodiments, the encoded video data is obtained for a portion of the video stream. The video data is decoded and a deblocking filter is adaptively applied based upon a comparison between the associated maximum bitrate and resolution of the encoded video data and the determined threshold values. In many embodiments, if the associated bitrate and resolution of the encoded video data are below the maximum bitrate and resolution thresholds, then the deblocking filter is applied. In various embodiments, if the associated maximum bitrate and resolution of the encoded video data are above the maximum bitrate and resolution thresholds, then the deblocking filter is not applied. In some embodiments, only one of the two threshold values are utilized in adaptively applying the deblocking filter. System architectures for adaptively applying a deblocking filter in accordance with embodiments of the invention are discussed further below.

### System Architecture

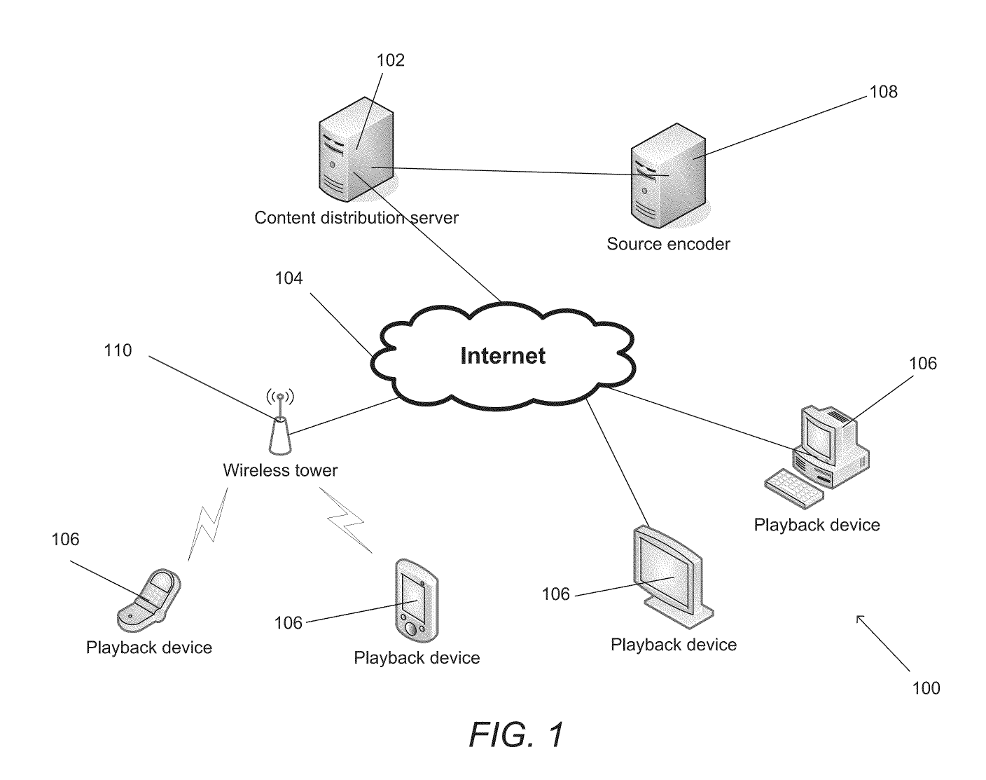

Encoded video can be transmitted to playback devices via any of a variety of networks including (but not limited to) the Internet. A video distribution system in accordance with an embodiment of the invention is illustrated in FIG. 1. The system 100 includes a number of different playback devices 106 connected with a content distribution server 102 over the Internet 104. A number of playback devices 106 communicate wirelessly with a cellular data network 110 to connect to the Internet 104. A source encoder 108, configured to encode video distributed from the content distribution server 102, is connected with the content distribution server 102. The playback devices 106 can include a decoder configured to decode encoded video that is encoded by the source encoder 108. Thereby, encoding, decoding and transfer of a video stream from the content distribution server 102 to a playback device 106 can occur. Although video transmitted to playback devices via the Internet is specifically discussed above, video can be transmitted to playback devices in any manner as appropriate to specific applications in accordance with many embodiments of the invention, including over a local access network or by removable memory, such as a CD-ROM.

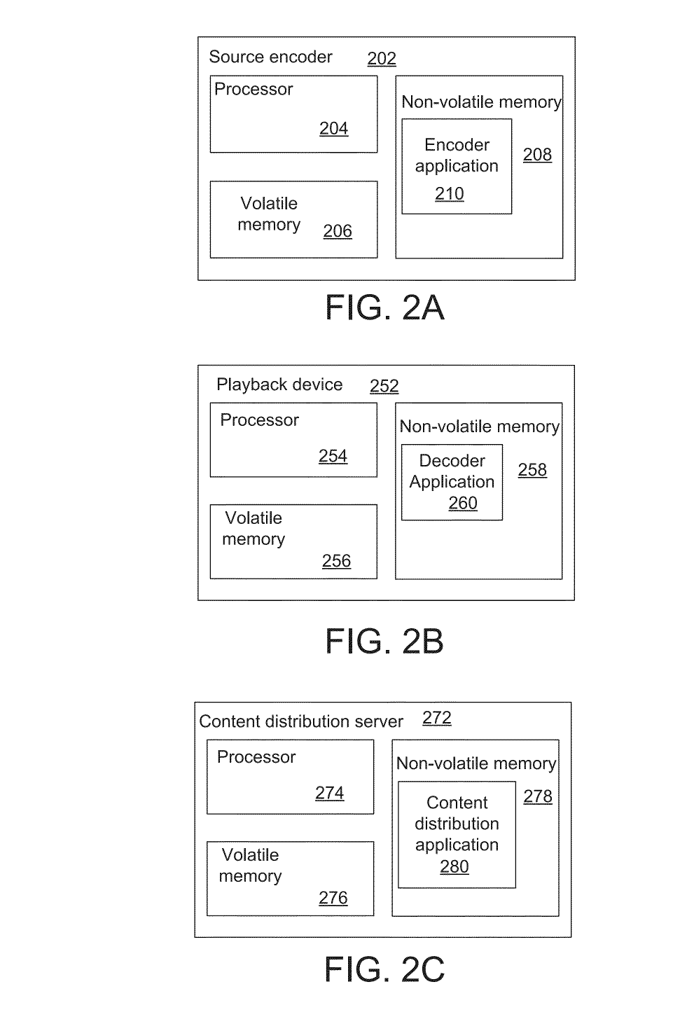

Source encoders in accordance with many embodiments of the invention can load an encoder application as machine readable instructions from memory or other storage. A source encoder in accordance with an embodiment of the invention is illustrated in FIG. 2A. The source encoder 202 includes a processor 204, volatile memory 206 and non-volatile memory 208 that includes an encoder 210. In the illustrated embodiment, the non-volatile memory 208 is a machine readable media that is utilized to store the machine readable instructions that configure the processor 204. The non-volatile memory 208 contains an encoder application 210, which is utilized to configure the processor 204 to encode video.

Similarly, playback devices in accordance with many embodiments of the invention can load a decoder application as machine readable instructions from memory. A playback device in accordance with an embodiment of the invention is illustrated in FIG. 2B. The playback device 252 includes a processor 254, volatile memory 256 and non-volatile memory 258 that includes a decoder application 260. In the illustrated embodiment, the non-volatile memory 258 is a machine readable media that is utilized to store the machine readable instructions that configure the processor 254. Here, the non-volatile memory 258 contains the instructions of a decoder application 260, which can be utilized to configure the processor 254 to decode video. Further, the adaptively deblocking filter can be loaded as part of the decoder application to configure the processor to adaptively apply a deblocking filter to decoded video. In many embodiments, a decoder application can be loaded from any kind of memory or storage device including memory in accordance with many embodiments of the invention.

In various embodiments, playback devices in accordance with many embodiments of the invention can utilize a single application to handle the downloading and the decoding of video data. For example, applications that stream video data real-time often utilize a single application to download and to decode video data. In other embodiments, separate applications can handle the downloading and the decoding of encoded video data. For example, a web browser could download a stream of video data and then play it back at a later time after post-processing the video data using a different application then the web browser application. Further, in many embodiments, the downloading application could measure the bitrate and forward such information to the decoder and/or instruct the decoder to adaptively apply the deblocking filter. In other embodiments, the decoder could measure the bitrate directly and decide whether or not to apply the deblocking filter (assuming the deblocking filter is an externally switchable feature of the decoder). In the same way that the decoder or downloading application could choose not to enable decoding, in some embodiments, the encoder could choose not to enable deblocking.

Content distribution servers in accordance with many embodiments of the invention can load a content distribution application as machine readable instructions from memory. A content distribution server in accordance with an embodiment of the invention is illustrated in FIG. 2C. The content distribution server 272 includes a processor 274, volatile memory 276 and non-volatile memory 278 that includes a content distribution application 280. In the illustrated embodiment, the non-volatile memory 278 is a machine readable media that is utilized to store the machine readable instructions that configure the processor 274. Here, the non-volatile memory 278 contains the instructions of a content distribution application 280, which can be utilized to configure the processor 274 to distribute video. In many embodiments, a content distribution application can be loaded from any kind of memory or storage device including volatile memory in accordance with many embodiments of the invention.

Although a video distribution system is described above with respect to a specific source encoder, content distribution server and playback devices, any of a variety of encoding, transmitting or decoding systems can be utilized in the encoding, decoding and transmission of video as appropriate to specific applications in accordance with many embodiments of the invention. Systems and methods for adaptively applying a deblocking filter in post-processing of video data in accordance with embodiments of the invention are discussed further below.

### Post-Processing by Adaptively Applying a Deblocking Filter

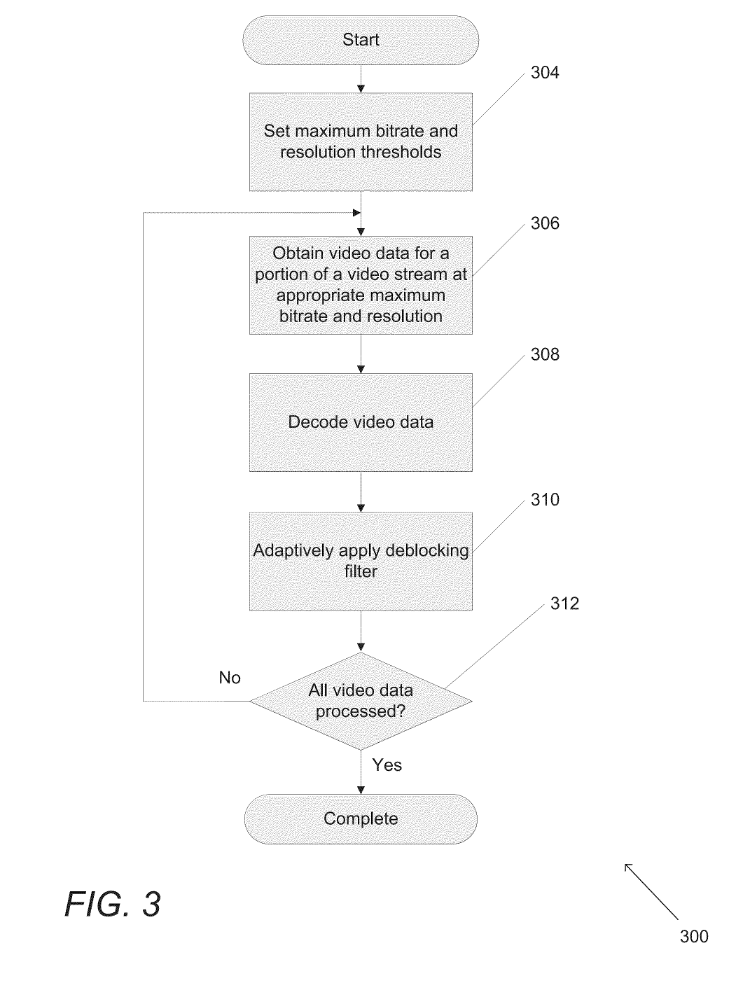

Compressed video content can exhibit varying degrees of blocking artifact depending on encoding parameters selected during the encoding process. A process for post-processing video content by adaptively applying a deblocking filter in accordance with an embodiment of the invention is shown in FIG. 3. The process 300 includes setting (304) maximum bitrate and resolution thresholds utilizing the characteristics of the particular playback device as further discussed below. In many embodiments, the process includes obtaining (306) video data for a portion of a video stream encoded at an appropriate maximum bitrate and resolution depending on the available transmission bandwidth between the playback device and content distribution server as further discussed below. In various embodiments, video data for the portion of the video stream is decoded (308) by the playback device using a decoder application in a manner well known to one of ordinary skill in the art. In many embodiments, a deblocking filter is adaptively applied (310) to the video data as further discussed below. A determination is made (312) as to whether all the video data for the video stream has been processed. If all video data has been processed, then the process 300 is complete. If all video data has not been processed, additional video data for a portion of the video stream is obtained (306), decoded (308), and processed (310) using an adaptive deblocking filter as discussed above.

Although specific processes for post-processing decoded video content by adaptively applying deblocking filters are discussed above with respect to FIG. 3, any of a variety of processes for post-processing decoded video data by adaptively applying deblocking filters as appropriate to the requirements of a specific application can be utilized in accordance with embodiments of the invention. Processes for setting the maximum bitrate and resolution thresholds in accordance with embodiments of the invention are discussed further below.

### Setting the Maximum Bitrate and Resolution Thresholds

The bitrate and resolution associated with a video file can give insight to the quality or lack of quality (including the amount of blocking artifact) that will be experienced during playback. Although different users can have varying degrees of what is considered acceptable quality, a minimum acceptable combination of bitrate and resolution can be predetermined.

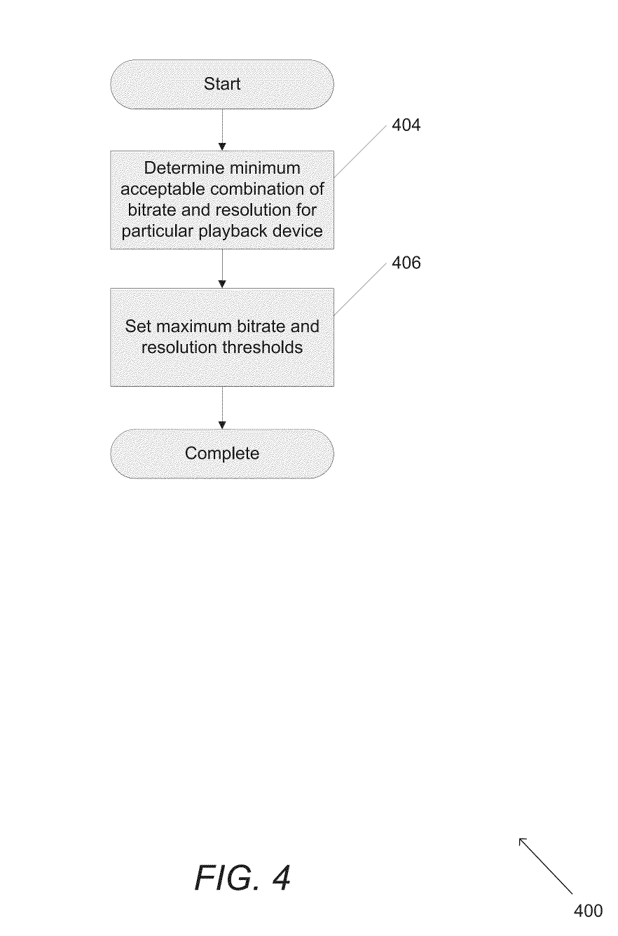

A process for setting maximum bitrate and resolution thresholds in accordance with an embodiment of the invention is shown in FIG. 4. The process 400 includes determining (404) the minimum acceptable combination of bitrate and resolution for a particular playback device. In many embodiments, the minimum acceptable combinations of bitrate and resolution will depend on a multitude of factors including (but not limited to) the native resolution of the playback device, the amount of motion in the video content, and/or the processing capabilities of the playback device. Further, the minimum acceptable combination of bitrate and resolution for any particular playback device can vary from video to video. In several embodiments, maximum bitrate and resolution thresholds are set (406) based upon the determined minimum acceptable combination of bitrate and resolution for a particular playback device.

Although specific processes for setting maximum bitrate and resolution thresholds by determining a minimum acceptable combination of bitrate and resolution are discussed above with respect to FIG. 4, any of a variety of processes for setting bitrate and resolution threshold values using minimum acceptable combinations of bitrate and resolution as appropriate to the requirements of a specific application can be utilized in accordance with embodiments of the invention. Processes for obtaining video data for a portion of a video stream at appropriate bitrate and resolution in accordance with embodiments of the invention are discussed further below.

### Obtaining Video Data for a Portion of a Video Stream at Appropriate Bitrate and Resolution

Video data is typically encoded at various bitrates and resolutions to accommodate different playback devices and data transfer speeds. Further, a single video file can be divided into smaller data portions where each data portion is encoded at multiple bitrate and resolution combinations for delivery via the content distribution server.

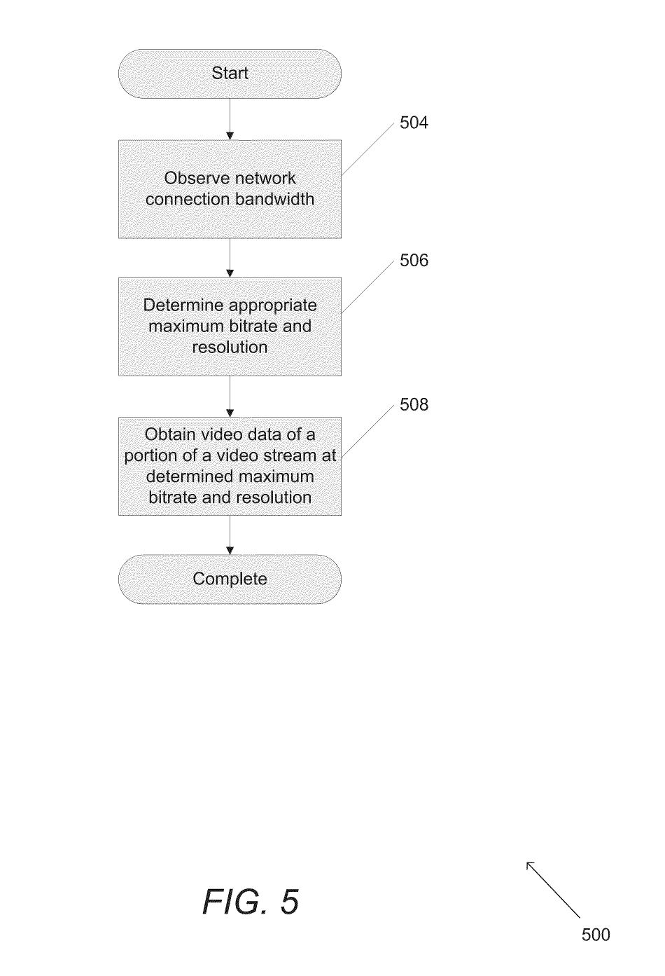

A process for obtaining video data for a portion of a video stream at an appropriate maximum bitrate and resolution in accordance with an embodiment of the invention is shown in FIG. 5. The process 500 includes observing (504) the network connection bandwidth between a playback device and a content distribution server to determine the download capacity in a manner well known to one of ordinary skill in the art. In many embodiments, an appropriate maximum bitrate and resolution are determined (506) using the observed network connection bandwidth in a manner well known to one of ordinary skill in the art. Video data for a portion of a video stream encoded with the appropriate maximum bitrate and resolution is obtained (508) from the content distribution server. Typically, greater bandwidths allow for obtaining video data encoded with higher bitrate and resolution combinations. However, in several embodiments, the maximum resolution can be determined based on the native resolution of the playback device. Thus, with greater available bandwidth, the resolution parameter can stay constant while the bitrate increases. In relatively lower available bandwidths, the bitrate and resolution parameters may both be reduced. In various embodiments, the appropriate maximum bitrate and resolution can be determined based on factors including (but not limited to) processor capacity, memory capacity and network data usage restrictions.

Although specific processes for obtaining video data for a portion of a video stream by determining an appropriate maximum bitrate and resolution are discussed above with respect to FIG. 5, any of a variety of processes for obtaining video data encoded using an appropriate maximum bitrate and resolution as appropriate to the requirements of a specific application can be utilized in accordance with embodiments of the invention. Processes for adaptively applying a deblocking filter to decoded video data for a portion of a video stream in accordance with embodiments of the invention are discussed further below.

### Adaptively Applying Deblocking Filters

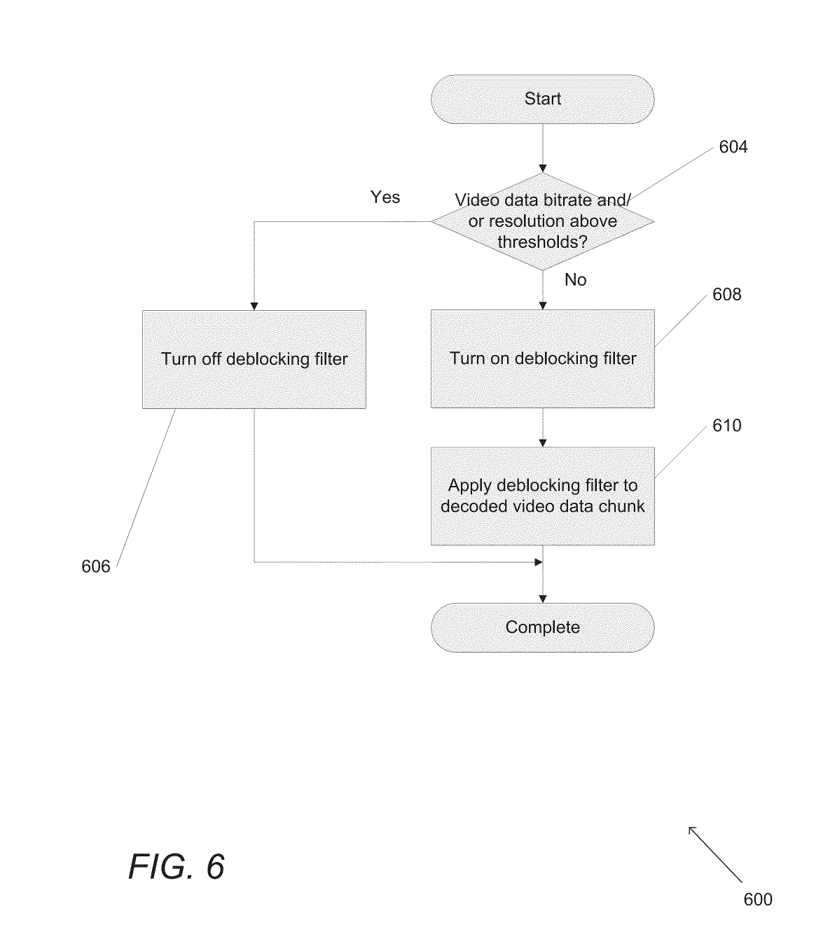

Deblocking filters can be applied to decoded video data to reduce blocking artifacts observed during playback. However, applying a deblocking filter uses valuable playback device resources such as computation power and battery life. A process for adaptively applying a deblocking filter in accordance with an embodiment of the invention is shown in FIG. 6. The process 600 includes determining (604) if a maximum bitrate and resolution associated with encoded video data for a portion of a video stream is within the maximum bitrate and/or resolution thresholds. If it is determined that the associated bitrate and/or resolution are above threshold values, then the deblocking filter is turned off (606) in a manner well known to one of ordinary skill in the art and a deblocking filter is not applied to the video data. However, if the associated bitrate and/or resolution are below the threshold values, then the deblocking filter is turned on (608) and a deblocking filter is applied (610) to the video data in a manner well known to one of ordinary skill in the art.

While network capacity can impose constraints related to the maximum bitrate of the stream, the processing capacity of the playback device is typically unconstrained by variations in network capacity. Therefore, a reduction in the resolution of the downloaded video typically results in a drop in the processing power utilized to decode the video, which in turn results in more processing power available for applying a deblocking filter. Furthermore, the computational load of applying the deblocking filter is low compared with applying the filter to higher resolution frames of video due to the fewer number of pixels to which the filter is applied.

Although specific processes for adaptively applying a deblocking filter utilizing maximum bitrate and/or resolution thresholds are discussed above with respect to FIG. 6, any of a variety of processes for adaptively applying a deblocking filter using maximum bitrate and/or resolution threshold values as appropriate to the requirements of a specific application can be utilized in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A method of post-processing encoded video data utilizing an adaptive deblocking filter comprising:
determining threshold values for maximum bitrate and resolution of encoded video based upon a minimum acceptable video quality for a playback device;
selecting a video stream comprising encoded video data with an associated maximum bitrate and resolution, where the video stream is selected based upon an available bandwidth between the playback device and a content distribution server;
obtaining encoded video data for a portion of the video stream with the associated maximum bitrate and resolution from the content distribution server;
decoding the video data for the portion of the video stream; and
adaptively applying the deblocking filter to the decoded video data for the portion of the video stream, where the deblocking filter is applied utilizing at least one of the determined maximum bitrate and resolution thresholds.

2. The method of claim 1, wherein determining threshold values for maximum bitrate and resolution parameters of encoded video further comprises loading the maximum bitrate and resolution thresholds from a non-volatile memory.

3. The method of claim 1, wherein the minimum acceptable video quality for a playback device further comprises determining an acceptable combination of bitrate and resolution for the playback device.

4. The method of claim 3, wherein the acceptable combination of bitrate and resolution for the playback device is based upon a native resolution of the playback device.

5. The method of claim 3, wherein the acceptable combination of bitrate and resolution for the playback device is based upon an amount of motion in the video content.

6. The method of claim 3, wherein the acceptable combination of bitrate and resolution for the playback device is based upon processing capacities of the playback device.

7. The method of claim 1, wherein the deblocking filter is a video filter that can be applied to decoded compressed video data to improve visual quality by smoothing edges between macroblocks.

8. The method of claim 1, wherein the deblocking filter is a video filter that can be applied to decoded compressed video data to improve prediction performance by smoothing edges between macroblocks.

9. The method of claim 1, wherein adaptively applying the deblocking filter further comprises applying the deblocking filter to the decoded video data from the portion of the video stream when the associated maximum bitrate and resolution of the obtained encoded video data is below the maximum bitrate and resolution thresholds.

10. The method of claim 9, wherein adaptively applying the deblocking filter further comprises not applying the deblocking filter to the decoded video data from the portion of the video stream when the associated maximum bitrate and resolution of the obtained encoded video data is above the maximum bitrate and resolution thresholds.

11. The method of claim 1, wherein the deblocking filter is applied based upon a comparison between the associated maximum bitrate of the obtained encoded video data and the maximum bitrate threshold.

12. The method of claim 1, wherein the deblocking filter is applied based upon a comparison between the associated resolution of the obtained encoded video data and the resolution threshold.

13. A playback device for providing playback by post-processing encoded video data utilizing an adaptive deblocking filter comprising:
memory; and
a processor configured via an application stored in the memory to:
determine threshold values for maximum bitrate and resolution of encoded video based upon a minimum acceptable video quality for the playback device;
select a video stream comprising encoded video data with an associated maximum bitrate and resolution, where the video stream is selected based upon an available bandwidth between the playback device and a content distribution server;
obtain encoded video data for a portion of the video stream with the associated maximum bitrate and resolution from the content distribution server;
decode the video data for the portion of the video stream; and
adaptively apply the deblocking filter to the decoded video data for the portion of the video stream, where the deblocking filter is applied utilizing at least one of the determined maximum bitrate and resolution thresholds.

14. The playback device of claim 13, wherein the processor configured via an application stored in the memory to determine threshold values for maximum bitrate and resolution parameters of encoded video further comprises loading the maximum bitrate and resolution thresholds from the memory.

15. The playback device of claim 13, wherein the minimum acceptable video quality for a playback device further comprises determining an acceptable combination of bitrate and resolution for the playback device.

16. The playback device of claim 15, wherein the acceptable combination of bitrate and resolution for the playback device is based upon a native resolution of the playback device.

17. The playback device of claim 15, wherein the acceptable combination of bitrate and resolution for the playback device is based upon an amount of motion in the video content.

18. The playback device of claim 15, wherein the acceptable combination of bitrate and resolution for the playback device is based upon processing capacities of the playback device.

19. The playback device of claim 13, wherein the deblocking filter is a video filter that can be applied to decoded compressed video data to improve visual quality by smoothing edges between macroblocks.

20. The playback device of claim 13, wherein the deblocking filter is a video filter that can be applied to decoded compressed video data to improve prediction performance by smoothing edges between macroblocks.

21. The playback device of claim 13, wherein the processor configured via an application stored in the memory to adaptively apply the deblocking filter further comprises applying the deblocking filter to the decoded video data from the portion of the video stream when the associated maximum bitrate and resolution of the obtained encoded video data is below the maximum bitrate and resolution thresholds.

22. The playback device of claim 21, wherein a processor configured via an application stored in the memory to adaptively apply the deblocking filter further comprises not applying the deblocking filter to the decoded video data from the portion of the video stream when the associated maximum bitrate and resolution of the obtained encoded video data is above the maximum bitrate and resolution thresholds.

23. The playback device of claim 13, wherein the deblocking filter is applied based upon a comparison between the associated maximum bitrate of the obtained encoded video data and the maximum bitrate threshold.

24. The playback device of claim 13, wherein the deblocking filter is applied based upon a comparison between the associated resolution of the obtained encoded video data and the resolution threshold.

25. The playback device of claim 13, wherein a plurality of applications are stored in the memory, wherein one application from the plurality of applications configures the processor to obtain encoded video data for a portion of the video stream and another application from the plurality of applications configures the processor to decode the video data.

26. The playback device of claim 25, wherein the application that configures the processor to obtain encoded video data from a portion of the video stream further configures the processor to measure the bitrate of the obtained video data and instructs the application that configures the processor to decode the video data to adaptively apply the deblocking filter to the decoded video data for the portion of the video stream based on the measured bitrate.

27. A machine readable medium containing processor instructions, where execution of the instructions by a processor causes the processor to perform a process for adaptively applying a deblocking filter to decoded video data, the process comprising:
determining threshold values for maximum bitrate and resolution of encoded video based upon a minimum acceptable video quality for a playback device;
selecting a video stream comprising encoded video data with an associated maximum bitrate and resolution, where the video stream is selected based upon an available bandwidth between the playback device and a content distribution server;
obtaining encoded video data for a portion of the video stream with the associated maximum bitrate and resolution from the content distribution server;
decoding the video data for the portion of the video stream; and
adaptively applying the deblocking filter to the decoded video data for the portion of the video stream, where the deblocking filter is applied utilizing at least one of the determined maximum bitrate and resolution thresholds.

28. The machine readable medium containing processor instructions of claim 27, wherein adaptively applying the deblocking filter further comprises applying the deblocking filter to the decoded video data from the portion of the video stream when the associated maximum bitrate and resolution of the obtained encoded video data is below the maximum bitrate and resolution thresholds.

29. The machine readable medium containing processor instructions of claim 28, wherein adaptively applying the deblocking filter further comprises not applying the deblocking filter to the decoded video data from the portion of the video stream when the associated maximum bitrate and resolution of the obtained encoded video data is above the maximum bitrate and resolution thresholds.
